(19) United States
(12) Patent Application Publication
(10) Pub. No.: US 2019/0005708 A1
(43) Pub. Date: Jan. 3, 2019

(54) METHOD AND DEVICE FOR GENERATING DESKTOP EFFECT AND ELECTRONIC DEVICE

(71) Applicant: BEIJING KINGSOFT INTERNET SECURITY SOFTWARE CO., LTD., Beijing (CN)

(72) Inventor: Wenbin Shao, Beijing (CN)

(73) Assignee: BEIJING KINGSOFT INTERNET SECURITY SOFTWARE CO., LTD., Beijing (CN)

(21) Appl. No.: 16/012,837

(22) Filed: Jun. 20, 2018

(30) Foreign Application Priority Data
Jun. 30, 2017 (CN) 201710525677.0

(51) Int. Cl. G06T 15/10; G06T 15/04; G06T 15/00; G06T 15/80; H04M 1/725

(52) U.S. Cl. CPC G06T 15/10; G06T 15/04; G06T 13/80; G06T 15/80; H04M 1/72544; G06T 15/005

(57) ABSTRACT

The present disclosure provides a method and a device for generating a desktop effect and an electronic device. The method includes: obtaining an image captured by a camera; loading the image as a texture map to a quadrilateral object to generate a first object; loading the first object to a container object to generate a second object; adding the second object to a preset service; and replacing a desktop wallpaper service with the preset service, and displaying a desktop effect corresponding to the preset service.

### CROSS-REFERENCE TO RELATED APPLICATIONS

This application claims priority to and benefits of Chinese Patent Application Serial No. 201710525677.0, filed with the State Intellectual Property Office of P. R. China on Jun. 30, 2017, the entire content of which is incorporated herein by reference.

### FIELD

The present disclosure relates to a mobile terminal technology field, and more particularly to a method and a device for generating a desktop effect and an electronic device.

### BACKGROUND

Android system is an important operating system of mobile terminals. The Android system becomes more and more powerful with continuous developments of technology. Via Android Launcher, abundant desktop effects may be realized, in which, one desktop effect “transparent desktop” is popular with users. According to “transparent desktop”, a desktop of the system becomes transparent and a scene in current real environment is directly displayed. At present, in a method for realizing “transparent desktop”, an image captured by a rear camera of the mobile phone is obtained, and the image is displayed on the desktop of the mobile phone, thus generating a “transparent” effect. In detail, a preview of the image captured by the camera of the mobile phone is obtained by relevant classes of Camera and CameraPreview in android.hardware.Camera, and the preview is put into Wallpaper Service of the Android system via SurfaceView, and then the preview is displayed as Wallpaper (a wallpaper of the system, i.e. Android desktop background) on the desktop of the mobile phone.

However, there are problems in the related art. Hardware of camera modules varies with mobile phones, and some mobile phones use a customized Android ROM (system package). Therefore, when the above mobile phones use “transparent desktop”, an effect of “inverted scene” may occur. This does not satisfy the effect that the user demands, and robustness, expandability and reusability are quite limited.

### SUMMARY

Embodiments of the present disclosure provides a method for generating a desktop effect, including: obtaining an image captured by a camera; loading the image as a texture map to a quadrilateral object to generate a first object; loading the first object to a container object to generate a second object; adding the second object to a preset service; and replacing a desktop wallpaper service with the preset service, and displaying a desktop effect corresponding to the preset service.

Embodiments of the present disclosure provides an electronic device, including: a housing, a processor, a memory and a display interface, in which the processor, the memory and the display interface are arranged inside a space enclosed by the housing, the processor is configured to, by reading an executable program code stored in the memory, run a program corresponding to the executable program code, so as to perform the method for generating a desktop effect according to the above embodiments.

Embodiments of the present disclosure provides a non-transitory computer readable storage medium, having stored therein a computer program that, when executed by a processor, causes the processor to perform the method for generating a desktop effect according to the above embodiments.

Additional aspects and advantages of embodiments of the present disclosure will be given in part in the following descriptions, become apparent in part from the following descriptions, or be learned from the practice of the embodiments of the present disclosure.

### BRIEF DESCRIPTION OF THE DRAWINGS

FIG. 1 is a flow char of a method for generating a desktop effect according to an embodiment of the present disclosure;

FIG. 2 is a schematic diagram illustrating an effect of “transparent desktop” according to an embodiment of the present disclosure;

FIG. 3 is a flow char of a method for generating a desktop effect according to another embodiment of the present disclosure;

FIG. 4 is a schematic diagram illustrating an effect of breaking a screen by shooting according to an embodiment of the present disclosure;

FIG. 5 is a block diagram illustrating a device for generating a desktop effect according to an embodiment of the present disclosure;

FIG. 6 is a block diagram illustrating a device for generating a desktop effect according to another embodiment of the present disclosure;

FIG. 7 is a block diagram illustrating a device for generating a desktop effect according to yet another embodiment of the present disclosure;

FIG. 8 is a block diagram illustrating a device for generating a desktop effect according to still another embodiment of the present disclosure;

FIG. 9 is a block diagram illustrating an electronic device according to an embodiment of the present disclosure.

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

A method and a device for generating a desktop effect according to embodiments of the present disclosure are described with reference to drawings.

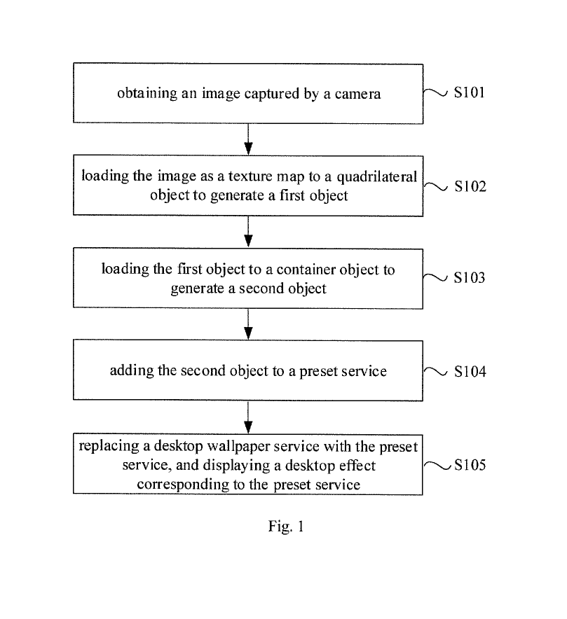

FIG. 1 is a flow char of a method for generating a desktop effect according to an embodiment of the present disclosure.

As illustrated in FIG. 1, the method for generating a desktop effect may include the followings.

At block S101, an image captured by a camera is obtained.

In an embodiment of the present disclosure, the image captured by the camera may be obtained with a Camera related class in a mobile terminal system.

At block S102, the image is loaded as a texture map to a quadrilateral object to generate a first object.

The first object is a 3D object.

In an embodiment of the present disclosure, the image may be converted into the texture map based on a 3D engine. And then, the texture map is loaded to the quadrilateral object via a shader program to generate the first object. For example, an image of 24 bits or an image of 32 bits is loaded via the 3D engine to generate the texture map. And then, by using the shader program, the texture map is loaded to the quadrilateral object (such as a rectangle object). A size of the quadrilateral object may be consistent with that of a screen of the mobile terminal.

The shader program may include a GLSL shader (OpenGL (open graphic library) shading language shader). The GLSL shader is a shader programed based on an OpenGL shading language, which mainly operates on a GPU (graphic processor unit) of a graphic chip to replace part of fixed rendering pipelines, such that different layers of the rendering pipelines has programmability, such as view transformation, projection transformation and the like. The GLSL shader may include a vertex shader and a fragment shader, sometimes may further include a geometry shader. The vertex shader is responsible for performing vertex shades, which may obtain current states in the OpenGL and realize transmission of built-in variables of the GLSL. The GLSL uses C language as a basic high-level shading language, thus avoiding complexity in using an assembly language or a hardware specification language.

At block S103, the first object is loaded to a container object to generate a second object.

In an embodiment of the present disclosure, the first object may be loaded to a container object of the 3D engine as a sub object, i.e. the second object. The container object is an object that allows other sub objects to be added inside it. The container object can exist alone as an object, and can exist as a parent of other objects. An appearance attribute of the container object may generally affect appearance of the sub objects inside it.

At block S104, the second object is added to a preset service.

After the second object is generated, the second object may be added to a customized service, i.e. the preset service.

At block S105, a desktop wallpaper service is replaced with the preset service, and a desktop effect corresponding to the preset service is displayed.

After the second object is added to the preset service, the preset service is used to replace the desktop wallpaper service, such that the desktop effect corresponding to the preset service is displayed. That is, WallpaperService in the operating system of the mobile terminal is replaced, and the customized service is rendered and displayed, thus realizing an effect of “transparent desktop”.

After this, a triggering operation may be received from a user, and then a corresponding animation effect is displayed according to the triggering operation.

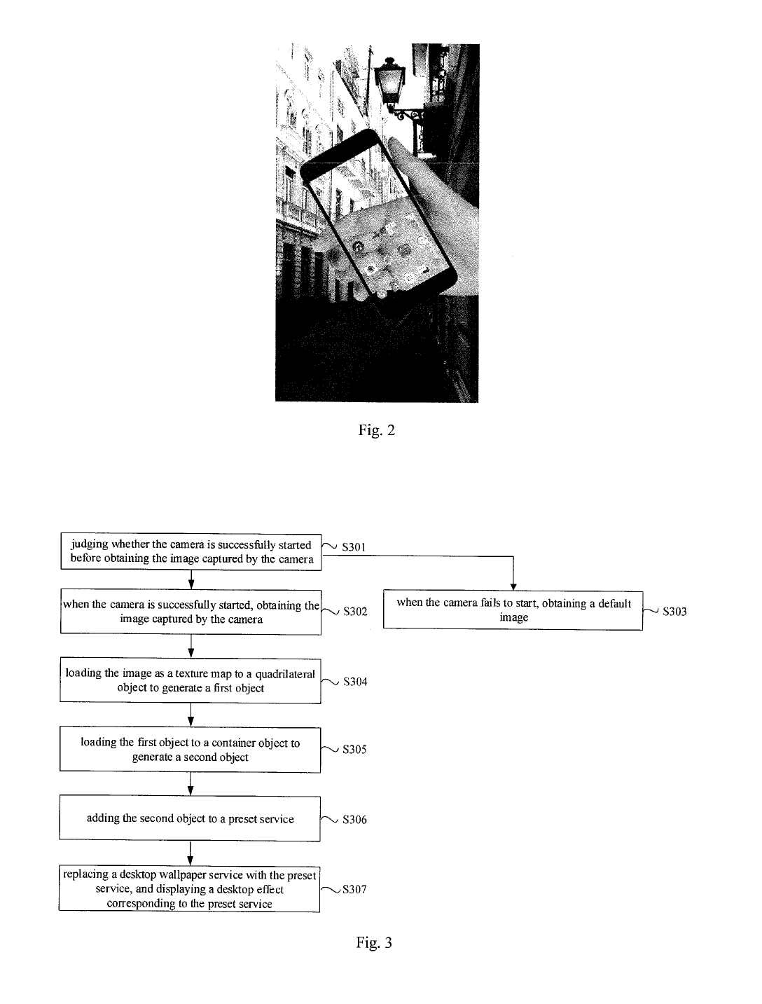

For example, the effect of “transparent desktop” may be realized based on the 3D engine of OpenGL and its exclusive script language XCML. The image captured by a rear camera may be obtained by using the Camera related class in an Android system. For example, a frame of image may be captured every 20 milliseconds, and each frame of image obtained is converted into a texture map by the 3D engine. And then the texture map is added, via the GLSL shader (a shader based on OpenGL), to a surface of a quadrangle packaged in the 3D engine to generate a 3D object. The 3D object together with other 3D objects in the 3D engine is added to a rendering sequence to render together, and the effect of “transparent desktop” illustrated in FIG. 2 is realized.

In order to solve a problem of image rotation difference caused by different default rotating direction of cameras of different terminals, the image is converted into the texture map by using the 3D engine, thus operations, such as rotation, translation, and the like, may be performed on the 3D object corresponding to the texture map with a high degree of freedom. The user may change a rotation angle according to his demand, thus realizing that an angle of the object displayed on the desktop remains consistent with a real angle.

With the method for generating a desktop effect according to embodiments of the present disclosure, by loading the image captured by the camera as the texture map to the quadrilateral object, and replacing the original desktop wallpaper service with the service corresponding to the generated object, the corresponding desktop effect is realized, thus satisfying the effect that a user demands, and improving robustness, expandability, and reusability of the effect.

FIG. 3 is a flow char of a method for generating a desktop effect according to another embodiment of the present disclosure.

As illustrated in FIG. 3, the method for generating a desktop effect includes the followings.

At block S301, it is judged whether the camera is successfully started before obtaining the image captured by the camera.

At block S302, when the camera is successfully started, the image captured by the camera is obtained.

At block S303, when the camera fails to start, a default image is obtained.

The default image may be a solid-colored image, such as a black image.

At block S304, the image is loaded as a texture map to a quadrilateral object to generate a first object.

In an embodiment of the present disclosure, the image may be converted into the texture map based on a 3D engine. And then, the texture map is loaded to the quadrilateral object via a shader program to generate the first object. For example, an image of 24 bits or an image of 32 bits is loaded via the 3D engine to generate the texture map. And then, by using the shader program, the texture map is loaded to the quadrilateral object (such as a rectangle object). A size of the quadrilateral object may be consistent with that of a screen of the mobile terminal.

At block S305, the first object is loaded to a container object to generate a second object.

In an embodiment of the present disclosure, the first object may be loaded to a container object of the 3D engine as a sub object, i.e. the second object. The container object is an object that allows other sub objects to be added inside it. The container object can exist alone as an object, and can exist as a parent of other objects. An appearance attribute of the container object may generally affect appearance of the sub objects inside it.

At block S306, the second object is added to a preset service.

After the second object is generated, the second object may be added to a customized service, i.e. the preset service.

At block S307, a desktop wallpaper service is replaced with the preset service, and a desktop effect corresponding to the preset service is displayed.

After the second object is added to the preset service, the preset service is used to replace the desktop wallpaper service, such that the desktop effect corresponding to the preset service is displayed. That is, WallpaperService in the operating system of the mobile terminal is replaced, and the customized service is rendered and displayed, thus realizing an effect of “transparent desktop”.

After this, a triggering operation may be received from a user, and then a corresponding animation effect is displayed according to the triggering operation.

For example, the effect of “transparent desktop” may be realized based on the 3D engine of OpenGL and its exclusive script language XCML. The image captured by a rear camera may be obtained by using the Camera related class in an Android system. For example, a frame of image may be captured every 20 milliseconds, and each frame of image obtained is converted into a texture map by the 3D engine. And then the texture map is added, via the GLSL shader (a shader based on OpenGL), to a surface of a quadrangle packaged in the 3D engine to generate a 3D object. The 3D object together with other 3D objects in the 3D engine is added to a rendering sequence to render together, and the effect of “transparent desktop” illustrated in FIG. 2 is realized.

In order to solve a problem of image rotation difference caused by different default rotating direction of cameras of different terminals, the image is converted into the texture map by using the 3D engine, thus operations, such as rotation, translation, and the like, may be performed on the 3D object corresponding to the texture map with a high degree of freedom. The user may change a rotation angle according to his demand, thus realizing that an angle of the object displayed on the desktop remains consistent with a real angle.

In addition, a plurality of attributes of the camera may be defined. And then, a corresponding effect is generated according to the plurality of defined attributes. The attributes may include transparency setting, filter selection, selection of a front camera or a rear camera, pausing or resuming the camera, and the like. For example, the XCML language may be used to define the attributes. The XCML language is a script programming language customized for a 3D theme, and integrated with individual modules of the 3D theme, such that effects such as 3D rotation, movement, and the like may be realized. Each module is defined with a form similar to XML label. Script files and resource files may be packaged to an encrypted cmt file. When the 3D theme is applied, a displaying effect may be realized by parsing and loading the cmt file. For example, camera related modules may be packaged to a “CameraPreview” class. The “CameraPreview” class has a plurality of attributes as follows. Front camera or rear camera selection, i.e., “isFontCamera”, is configured to define whether to call the front camera or the rear camera. For example, it may be defined that, a value of “isFontCamera” being equal to 1 is set to call the front camera, and a value of “isFontCamera” being equal to 2 is set to call the rear camera. When “isFontCamera”=1, the front camera may be called, thus the front camera is controlled to start, such that an image captured by the front camera is obtained. At this time, the user is facing the front camera to take a photo of himself, a mirror effect may be simulated. Filter selection “colorEffect” is configured to define a filter effect. For example, there are currently eight hues of filter such as vintage, fresh, black/white, and the like, with values of 1 to 8 respectively. When “colorEffect”=1, it is known that the vintage filter is called, and then the vintage filter is opened, and an effect displayed by the camera is the vintage effect. Transparency setting “alpha” is configured to define a display transparency. The transparency may be defined with percentage. For example, a value 50% presents a half-transparent picture. A mask effect may be realized by superposing the half-transparent picture and the image. A method of pausing or resuming the camera, i.e., “pauseCamera” and “resumeCamera”, defines a pausing or resuming of the camera. For example, when “pauseCamera”=1, it presents that the camera is paused. At this time, the desktop effect is a default effect, and the camera is not opened, thus realizing reducing power consumption.

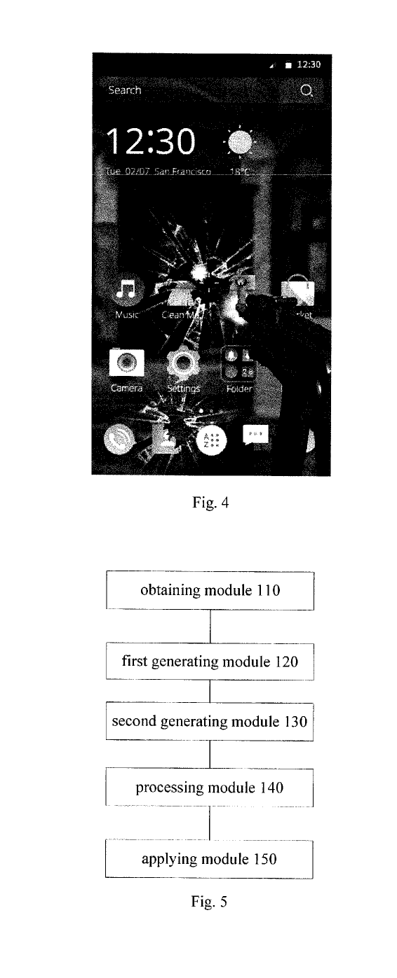

By using the 3D engine and the XCML, it can realize an effect of breaking a screen by shooting. With the XCML, a mask layer may be packaged, and a 3D rifle model is added on the mask layer. It is defined that the model is be able to produce a rotating effect with values detected by a gravity sensor. When the user clicks the screen of a terminal, a position where the user touches may be detected, and the rifle may perform an animation effect of shooting, at the same time, an image of a broken screen is displayed and added as a mask layer to the position where the user touches, thus the effect of breaking a screen by shooting illustrated in FIG. 4 is finally realized.

With the method for generating a desktop effect according to embodiments of the present disclosure, by using the 3D engine and the XCML, different desktop effects may be flexibly defined, thus displaying is easier, effects are more abundant, satisfying user's demand.

To achieve above objectives, the present disclosure further provides a device for generating a desktop effect.

FIG. 5 is a block diagram illustrating a device for generating a desktop effect according to an embodiment of the present disclosure.

As illustrated in FIG. 5, the device for generating a desktop effect according to an embodiment of the present disclosure may include an obtaining module 110, a first generating module 120, a second generating module 130, a processing module 140 and an applying module 150.

The obtaining module 110 is configured to obtain an image captured by a camera.

In an embodiment of the present disclosure, the image captured by the camera may be obtained with a Camera related class in a mobile terminal system.

The first generating module 120 is configured to load the image as a texture map to a quadrilateral object to generate a first object.

Alternatively, the first generating module 120 is configured to convert the image into the texture map based on a 3D engine, and to load the texture map to the quadrilateral object via a shader program to generate the first object.

The first object is a 3D object.

In an embodiment of the present disclosure, the image may be converted into the texture map based on a 3D engine. And then, the texture map is loaded to the quadrilateral object via a shader program to generate the first object. For example, an image of 24 bits or an image of 32 bits is loaded via the 3D engine to generate the texture map. And then, by using the shader program, the texture map is loaded to the quadrilateral object (such as a rectangle object). A size of the quadrilateral object may be consistent with that of a screen of the mobile terminal.

The shader program may include a GLSL shader. The GLSL shader is a shader programed based on an OpenGL shading language, which mainly operates on a GPU (graphic processor unit) of a graphic chip to replace part of fixed rendering pipelines, such that different layers of the rendering pipelines has programmability, such as view transformation, projection transformation and the like. The GLSL shader may include a vertex shader and a fragment shader, sometimes may further include a geometry shader. The vertex shader is responsible for performing vertex shades, which may obtain current states in the OpenGL and realize transmission of built-in variables of the GLSL. The GLSL uses C language as a basic high-level shading language, thus avoiding complexity in using an assembly language or a hardware specification language.

The second generating module 130 is configured to load the first object to a container object to generate a second object.

In an embodiment of the present disclosure, the first object may be loaded to a container object of the 3D engine as a sub object, i.e. the second object. The container object is an object that allows other sub objects to be added inside it. The container object can exist alone as an object, and can exist as a parent of other objects. An appearance attribute of the container object may generally affect appearance of the sub objects inside it.

The processing module 140 is configured to add the second object to a preset service.

The applying module 150 is configured to replace a desktop wallpaper service with the preset service, and to display a desktop effect corresponding to the preset service.

After the second object is added to the preset service, the preset service is used to replace the desktop wallpaper service, such that the desktop effect corresponding to the preset service is displayed. That is, WallpaperService in the operating system of the mobile terminal is replaced, and the customized service is rendered and displayed, thus realizing an effect of “transparent desktop”.

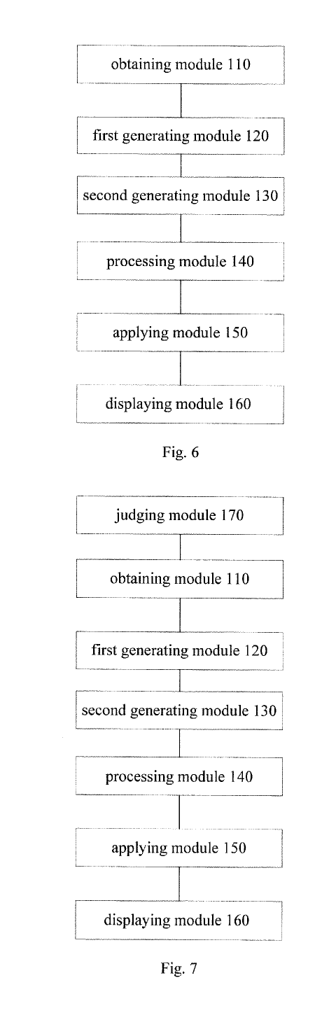

In addition, as illustrated in FIG. 6, the device for generating a desktop effect according to embodiments of the present disclosure may further include a displaying module 160.

The displaying module 160 is configured to receive a triggering operation from a user after the desktop effect corresponding to the preset service is displayed, and to display a corresponding animation effect according to the triggering operation.

For example, the effect of “transparent desktop” may be realized libraryd on the 3D engine of OpenGL and its exclusive script language XCML. The image captured by a rear camera may be obtained by using the Camera related class in an Android system. For example, a frame of image may be captured every 20 milliseconds, and each frame of image obtained is converted into a texture map by the 3D engine. And then the texture map is added, via the GLSL shader (a shader based on OpenGL), to a surface of a quadrangle packaged in the 3D engine to generate a 3D object. The 3D object together with other 3D objects in the 3D engine is added to a rendering sequence to render together, and the effect of “transparent desktop” illustrated in FIG. 2 is realized.

In order to solve a problem of image rotation difference caused by different default rotating direction of cameras of different terminals, the image is converted into the texture map by using the 3D engine, thus operations, such as rotation, translation, and the like, may be performed on the 3D object corresponding to the texture map with a high degree of freedom. The user may change a rotation angle according to his demand, thus realizing that an angle of the object displayed on the desktop remains consistent with a real angle.

In addition, as illustrated in FIG. 7, the device for generating a desktop effect according to embodiments of the present disclosure may further include a judging module 170.

The judging module 170 is configured to judge whether the camera is successfully started before obtaining the image captured by the camera.

When the camera is successfully started, the obtaining module 110 obtains the image captured by the camera.

When the camera fails to start, the obtaining module 110 obtains a default image.

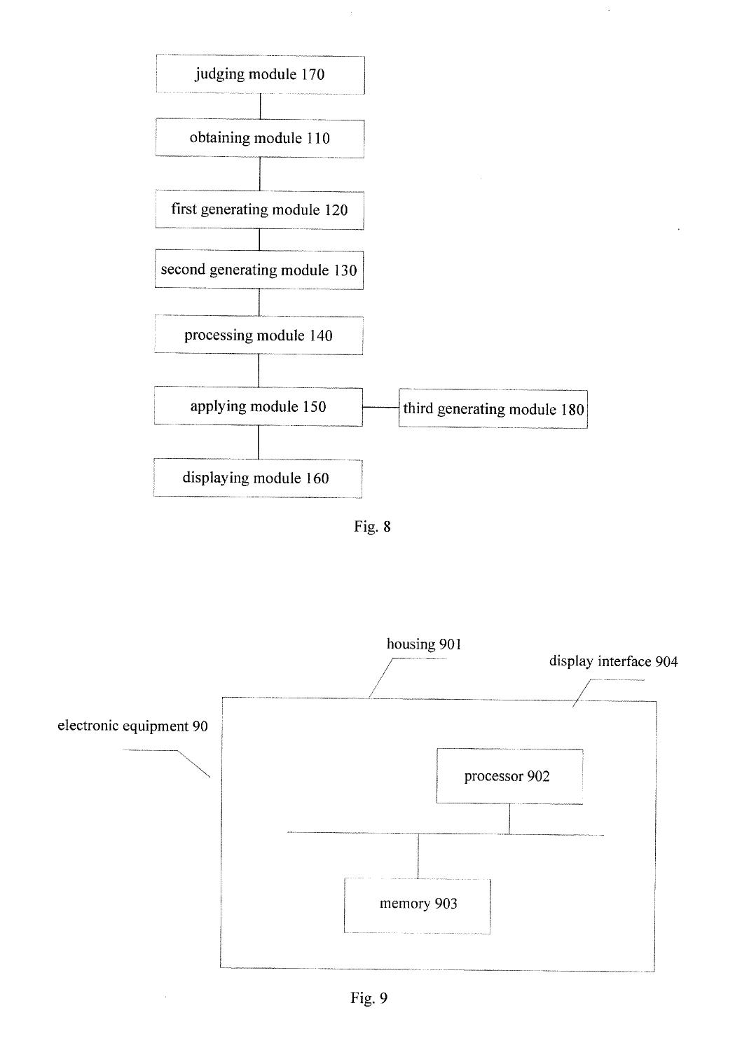

In addition, as illustrated in FIG. 8, the device for generating a desktop effect according to embodiments of the present disclosure may further include a third generating module 180.

The third generating module 180 is configured to define a plurality of attributes of the camera, and to generate a corresponding desktop effect according to the plurality of defined attributes.

The attributes comprise transparency setting, filter selection, selection of a front camera or a rear camera, pausing or resuming the camera. For example, the XCML language may be used to define the attributes. The XCML language is a script programming language customized for a 3D theme, and integrated with individual modules of the 3D theme, such that effects such as 3D rotation, movement, and the like may be realized. Each module is defined with a form similar to XML label. Script files and resource files may be packaged to an encrypted cmt file. When the 3D theme is applied, a displaying effect may be realized by parsing and loading the cmt file. For example, camera related modules may be packaged to a “CameraPreview” class. The “CameraPreview” class has a plurality of attributes as follows. Front camera or rear camera selection, i.e., “isFontCamera”, is configured to define whether to call the front camera or the rear camera. For example, it may be defined that, a value of “isFontCamera” being equal to 1 is set to call the front camera, and a value of “isFontCamera” being equal to 2 is set to call the rear camera. When “isFontCamera”=1, the front camera may be called, thus the front camera is controlled to start, such that an image captured by the front camera is obtained. At this time, the user is facing the front camera to take a photo of himself, a mirror effect may be simulated. Filter selection “colorEffect” is configured to define a filter effect. For example, there are currently eight hues of filter such as vintage, fresh, black/white, and the like, with values of 1 to 8 respectively. When “colorEffect”=1, it is known that the vintage filter is called, and then the vintage filter is opened, and an effect displayed by the camera is the vintage effect. Transparency setting “alpha” is configured to define a display transparency. The transparency may be defined with percentage. For example, a value 50% presents a half-transparent picture. A mask effect may be realized by superposing the half-transparent picture and the image. A method of pausing or resuming the camera, i.e., “pauseCamera” and “resumeCamera”, defines a pausing or resuming of the camera. For example, when “pauseCamera”=1, it presents that the camera is paused. At this time, the desktop effect is a default effect, and the camera is not opened, thus realizing reducing power consumption.

By using the 3D engine and the XCML, it can realize an effect of breaking a screen by shooting. With the XCML, a mask layer may be packaged, and a 3D rifle model is added on the mask layer. It is defined that the model is be able to produce a rotating effect with values detected by a gravity sensor. When the user clicks the screen of a terminal, a position where the user touches may be detected, and the rifle may perform an animation effect of shooting, at the same time, an image of a broken screen is displayed and added as a mask layer to the position where the user touches, thus the effect of breaking a screen by shooting illustrated in FIG. 4 is finally realized.

With the device for generating a desktop effect according to embodiments of the present disclosure, by loading the image captured by the camera as the texture map to the quadrilateral object, and replacing the original desktop wallpaper service with the service corresponding to the generated object, the corresponding desktop effect is realized, thus satisfying the effect that a user demands, and improving robustness, expandability, and reusability of the effect.

To realize above embodiments, the present disclosure further provides an electronic device.

FIG. 9 is a block diagram illustrating an electronic device according to an embodiment of the present disclosure.

As illustrated in FIG. 9, the electronic device includes: a housing 901, and a processor 902, a memory 903 and a display interface 904. The processor 902, the memory 903 and the display interface 904 are arranged inside a space enclosed by the housing 901. The processor 902 is configured to, by reading an executable program code stored in the memory 903, run a program corresponding to the executable program code, so as to perform the method for generating a desktop effect according to the above-mentioned embodiments.

With the electronic device according to embodiments of the present disclosure, by loading the image captured by the camera as the texture map to the quadrilateral object, and replacing the original desktop wallpaper service with the service corresponding to the generated object, the corresponding desktop effect is realized, thus satisfying the effect that a user demands, and improving robustness, expandability, and reusability of the effect.

To realize above embodiments, the present disclosure further provides a non-transitory computer readable storage medium, having stored therein a computer program that, when executed by a processor, causes the processor to perform the method for generating a desktop effect according to the above-mentioned embodiments.

In addition, terms such as “first” and “second” are used herein for purposes of description and are not intended to indicate or imply relative importance or significance. Thus, the feature defined with “first” and “second” may comprise one or more this feature. In the description of the present disclosure, “a plurality of” means two or more than two, such as two or three, unless specified otherwise.

It will be understood that, the flow chart or any process or method described herein in other manners may represent a module, segment, or portion of code that comprises one or more executable instructions to implement the specified logic function(s) or that comprises one or more executable instructions of the steps of the progress. Although the flow chart shows a specific order of execution, it is understood that the order of execution may differ from that which is depicted. For example, the order of execution of two or more boxes may be scrambled relative to the order shown. Also, two or more boxes shown in succession in the flow chart may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure. Also, the flow chart is relatively self-explanatory and is understood by those skilled in the art to the extent that software and/or hardware can be created by one with ordinary skill in the art to carry out the various logical functions as described herein.

The logic and step described in the flow chart or in other manners, for example, a scheduling list of an executable instruction to implement the specified logic function(s), it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the printer registrar for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the device, system, and method of the present disclosure is embodied in software or code executed by general purpose hardware as discussed above, as an alternative the device, system, and method may also be embodied in dedicated hardware or a combination of software/general purpose hardware and dedicated hardware. If embodied in dedicated hardware, the device or system can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

It can be understood that all or part of the steps in the method of the above embodiments can be implemented by instructing related hardware via programs, the program may be stored in a computer readable storage medium, and the program includes one step or combinations of the steps of the method when the program is executed.

In addition, each functional unit in the present disclosure may be integrated in one progressing module, or each functional unit exists as an independent unit, or two or more functional units may be integrated in one module. The integrated module can be embodied in hardware, or software. If the integrated module is embodied in software and sold or used as an independent product, it can be stored in the computer readable storage medium.

The computer readable storage medium may be, but is not limited to, read-only memories, magnetic disks, or optical disks.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A method for generating a desktop effect, comprising:
obtaining an image captured by a camera;
loading the image as a texture map to a quadrilateral object to generate a first object;
loading the first object to a container object to generate a second object;
adding the second object to a preset service; and
replacing a desktop wallpaper service with the preset service, and displaying a desktop effect corresponding to the preset service.

2. The method according to claim I, further comprising:
receiving a triggering operation from a user after displaying the desktop effect corresponding to the preset service; and
displaying a corresponding animation effect according to the triggering operation.

3. The method according to claim 1, wherein loading the image as a texture map to a quadrilateral object to generate a first object comprises:
converting the image into the texture map based on a 3D engine; and
loading the texture map to the quadrilateral object via a shader program to generate the first object, wherein the first object is a 3D object.

4. The method according to claim 1, further comprising:
judging whether the camera is successfully started before obtaining the image captured by the camera;
when the camera is successfully started, obtaining the image captured by the camera;
when the camera fails to start, obtaining a default image.

5. The method according to claim 1, further comprising:
defining a plurality of attributes of the camera, wherein the attributes comprise transparency setting, filter selection, selection of a front camera or a rear camera, pausing or resuming the camera; and
generating a corresponding desktop effect according to the plurality of defined attributes.

6. An electronic device, comprising following one or more components: a housing, a processor, a memory and a display interface, wherein the processor, the memory and the display interface are arranged inside a space enclosed by the housing, the processor is configured to, by reading an executable program code stored in the memory, run a program corresponding to the executable program code, so as to perform acts of:
obtaining an image captured by a camera;
loading the image as a texture map to a quadrilateral object to generate a first object;
loading the first object to a container object to generate a second object;
adding the second object to a preset service; and
replacing a desktop wallpaper service with the preset service, and displaying a desktop effect corresponding to the preset service.

7. The electronic device according to claim 6, wherein the processor is further configured to perform acts of:
receiving a triggering operation from a user after displaying the desktop effect corresponding to the preset service; and
displaying a corresponding animation effect according to the triggering operation.

8. The electronic device according to claim 6, wherein the processor is configured to load the image as a texture map to a quadrilateral object to generate a first object by acts of:
converting the image into the texture map based on a 3D engine; and
loading the texture map to the quadrilateral object via a shader program to generate the first object, wherein the first object is a 3D object.

9. The electronic device according to claim 6, wherein the processor is further configured to perform acts of:
judging whether the camera is successfully started before obtaining the image captured by the camera;
when the camera is successfully started, obtaining the image captured by the camera;
when the camera fails to start, obtaining a default image.

10. The electronic device according to claim 6, wherein the processor is further configured to perform acts of:
defining a plurality of attributes of the camera, wherein the attributes comprise transparency setting, filter selection, selection of a front camera or a rear camera, pausing or resuming the camera; and
generating a corresponding desktop effect according to the plurality of defined attributes.

11. A non-transitory computer readable storage medium, having stored therein a computer program that, when executed by a processor, causes the processor to perform a method for generating a desktop effect, the method comprising:
obtaining an image captured by a camera;
loading the image as a texture map to a quadrilateral object to generate a first object;
loading the first object to a container object to generate a second object;
adding the second object to a preset service; and
replacing a desktop wallpaper service with the preset service, and displaying a desktop effect corresponding to the preset service.

12. The non-transitory computer readable storage medium according to claim 11, wherein the method further comprises:
receiving a triggering operation from a user after displaying the desktop effect corresponding to the preset service; and
displaying a corresponding animation effect according to the triggering operation.

13. The non-transitory computer readable storage medium according to claim 11, wherein loading the image as a texture map to a quadrilateral object to generate a first object comprises:
converting the image into the texture map based on a 3D engine; and
loading the texture map to the quadrilateral object via a shader program to generate the first object, wherein the first object is a 3D object.

14. The non-transitory computer readable storage medium according to claim 11, wherein the method further comprises:
judging whether the camera is successfully started before obtaining the image captured by the camera;
when the camera is successfully started, obtaining the image captured by the camera;
when the camera fails to start, obtaining a default image.

15. The non-transitory computer readable storage medium according to claim 11, wherein the method further comprises:
defining a plurality of attributes of the camera, wherein the attributes comprise transparency setting, filter selection, selection of a front camera or a rear camera, pausing or resuming the camera; and
generating a corresponding desktop effect according to the plurality of defined attributes.
